(19) United States
(12) Patent Application Publication
(10) Pub. No.: US 2026/0313518 A1
(43) Pub. Date: Oct. 8, 2026

(54) ACTIVE SECONDARY SERVICE SET IDENTIFIER CLIENT CONTROL

(71) Applicant: Charter Communications Operating, LLC, St. Louis, MO (US)

(72) Inventors: Pratiksha Shukla, Parker, CO (US); Ryan Loaiza, Brighton, CO (US)

(73) Assignee: Charter Communications Operating, LLC, St. Louis, MO (US)

(21) Appl. No.: 19/169,129

(22) Filed: Apr. 3, 2025

(51) Int. Cl. H04W 48/06; H04W 28/02

(52) U.S. Cl. CPC H04W 48/06; H04W 28/0236

(57) ABSTRACT

Devices and methods which provide active secondary service set identifier (SSID) client control. The method includes comparing, by a client control engine in an access point, a total on-channel utilization against a connection threshold when a client attempts to attach to a secondary SSID, wherein the total on-channel utilization includes utilization across a primary SSID and the secondary SSID, attaching a client to the secondary SSID when the total on-channel utilization is less than the connection threshold, monitoring, by a monitor engine, secondary SSID utilization with respect to the total on-channel utilization, checking, by a pre-mitigation engine, performance of a primary SSID client when the secondary SSID utilization exceeds or is equal to a defined percentage of the total on-channel utilization, and executing, by a mitigation engine, at least one of a client throttling or disassociation of secondary SSID client(s) when the performance of the primary SSID client is degraded.

### TECHNICAL FIELD

This disclosure relates to communications. More specifically, access point management and control.

### BACKGROUND

An access point enables radio communications between mobile and/or wireless-capable devices (collectively “mobile devices”), stationary wireless capable devices, and a wired network. A service set identifier (SSID) is a name of a wireless network that is supported by one or more access points. The access points can broadcast one or more SSIDs for access by mobile devices and/or stationary wireless capable devices, i.e., the access points can support or host multiple wireless networks. In the instance of multiple SSIDs, one of the multiple SSIDs can be referred to as a primary or private SSID (collectively “primary SSID”) and the remaining SSID(s) can be referred to as secondary or guest SSID(s) (collectively “secondary SSID(s)”). The mobile devices and/or stationary wireless capable devices attached to the secondary SSID(s) can detrimentally impact the services and/or service levels provided to the mobile devices and/or stationary wireless capable devices attached to the primary SSID.

### SUMMARY

Disclosed is a device and method for providing active secondary service set identifier (SSID) client control. In implementations, a method for providing active secondary service set identifier (SSID) client control includes comparing, by a client control engine in an access point, a total on-channel utilization against a connection threshold when a client attempts to attach to a secondary SSID of the access point, wherein the total on-channel utilization includes utilization across a primary SSID and the secondary SSID, attaching, by the access point, a client to the secondary SSID when the total on-channel utilization is less than the connection threshold, monitoring, by a monitor engine of the client control engine, secondary SSID utilization with respect to the total on-channel utilization, checking, by a pre-mitigation engine of the client control engine, performance of a primary SSID client when the secondary SSID utilization exceeds or is equal to a defined percentage of the total on-channel utilization, and executing, by a mitigation engine of the client control engine, at least one of a client throttling or a client disassociation of at least one secondary SSID client when the performance of the primary SSID client is degraded.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of an access point in accordance with the teachings described herein.

FIG. 2 is a diagram of a graph of on-channel utilization in accordance with the teachings described herein.

FIG. 3 is a flow diagram of an example client control engine flow for providing active secondary service set identifier (SSID) client control in accordance with the teachings described herein.

FIG. 4 is a flow diagram of an example monitor engine flow for providing active SSID client control in accordance with the teachings described herein.

FIG. 5 is a flow diagram of an example pre-mitigation engine flow for providing active secondary SSID client control in accordance with the teachings described herein.

FIG. 6 is a flow diagram of an example mitigation engine flow for providing active secondary SSID client control in accordance with the teachings described herein.

FIG. 7 is a flowchart of an example method for providing active secondary SSID client control in accordance with the teachings described herein.

FIG. 8 is a flowchart of another example method for providing active secondary SSID client control in accordance with the teachings described herein.

FIG. 9 is a block diagram of an example of a device in accordance with the teachings described herein.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described teachings and/or embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed teachings and/or embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

An access point enables radio communications between mobile devices and/or stationary wireless capable devices, and a wired network by broadcasting multiple SSIDs. The multiple SSIDs can include a primary SSID and one or more secondary SSID(s). The access point can be configured to support the multiple SSIDs using two techniques.

In a first technique, the access point can have dedicated and/or separate radios for the primary SSID and the secondary SSID(s). The radios can operate on different bands. In this configuration, the primary SSID is prevented from using the other radio and band. Although the primary SSID and associated network is isolated and protected from the secondary network traffic, the primary SSID and associated network loses the ability to band steer and use the other radio and band. Moreover, this configuration limits throughput of each SSID and the access point.

In a second technique, the access point can have a radio and band that is shared by the primary SSID and the secondary SSID(s). In this configuration, operators can set a pre-defined maximum throughput allocation for the secondary SSID through backend services and can mark secondary SSID traffic exclusively as background traffic. However, when the secondary SSID is actively serving clients and/or client devices (collectively “clients”) there is no mechanism in place to guarantee that the latency experienced by the primary SSID's clients do not increase significantly, thus degrading its performance. The clients can include, but is not limited to, mobile devices.

For example, if the secondary SSID clients are requesting to use more airtime than what is available, then the primary SSID client traffic may experience increased latency, and customers may be unable to utilize their subscribed service speeds over Wi-Fi. Currently, there is no procedure to dictate when the secondary SSID clients should be dropped or prevented from joining the network and/or attaching to the access point to ensure better performance for the primary SSID clients.

Described herein is a device and method for providing active secondary SSID client control. In implementations, the system and methods can use performance parameters to throttle and/or disassociate secondary SSID client(s) to ensure that the primary SSID clients' performance is not negatively impacted due to the secondary SSID clients. In implementations, the performance parameters can include, but is not limited to, on-channel utilization of the access point, ratio of on-channel utilization with respect to the secondary SSID utilization and the total on-channel utilization, latency experienced by the primary SSID clients, signal-to-noise (SNR) of the primary SSID clients, and/or combinations thereof.

In implementations, a ratio of secondary SSID utilization with respect to total utilization of a serving channel can be calculated and monitored to determine whether further actions are required. In the event further actions are required, the primary SSIDs'clients'performance degradation can be assessed over a defined timeframe for a defined amount of time. For example, it can be determined whether the primary SSIDs'clients'latency is on an upward trend (i.e., the latency is getting worse or longer). In implementations, the defined timeframe and the defined amount of time can be system configurable, user configurable, operator configurable, and/or combinations thereof. In the event that the primary SSIDs'clients'latency is upwardly trending, then the secondary SSID clients can be throttled and/or disassociated in a defined order until the primary SSIDs'clients'performance improves or there are no more secondary SSID clients remaining.

In implementations, methods are provided which control the secondary SSID client association based on primary SSID performance.

In implementations, methods are provided which detect if a primary SSID client performance is being impacted by secondary SSID clients.

In implementations, methods are provided which detect the performance trends of primary SSID clients and base client control decisions on that information.

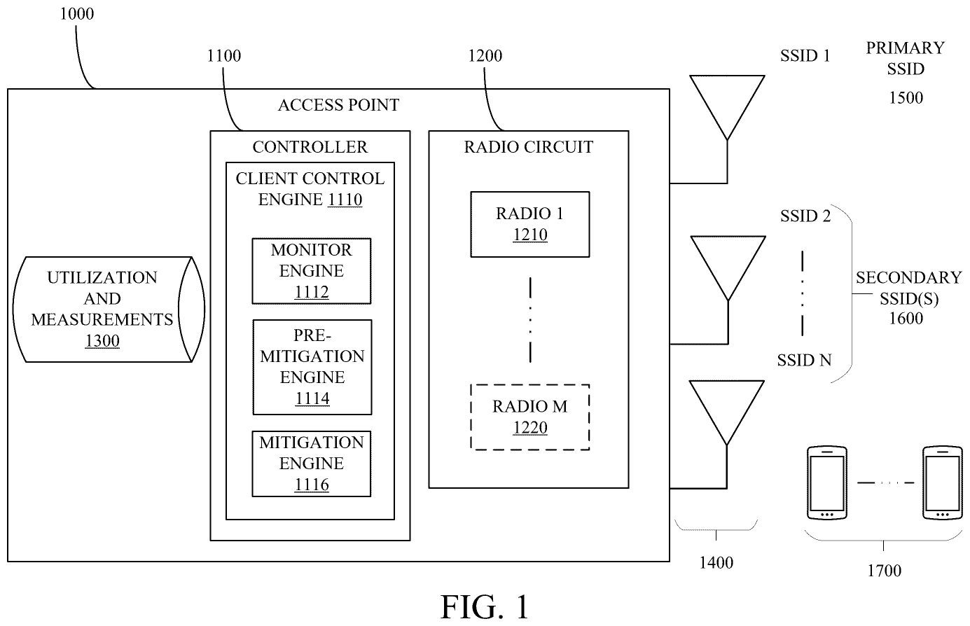

FIG. 1 is a diagram of an example of an access point 1000 in accordance with the teachings described herein. The access point 1000 can be an access point, an access node, an access device, a wireless router, a gateway, and/or like device which enables radio communications access for a client(s) 1700 toward and/or from an external network including, but not limited to, a service provider network, the internet, and/or other systems. The access point 1000 may provide local wireless coverage (e.g., Wi-Fi coverage) and/or enable a wireless local access network(s).

In implementations, the access point 1000 can include, but is not limited to, a controller 1100, a radio circuit 1200, a database 1300, and an antenna 1400. The access point 1000, via the collective functions of the controller 1100, the radio circuit 1200, the database 1300, and the antenna 1400 can provide and broadcast multiple SSIDs including, but not limited to, SSID 1 and/or primary SSID 1500 (collectively “primary SSID 1500”) and SSID 2 . . . N and/or secondary SSIDs 1600 (collectively “secondary SSID(s) 1600”), such that wireless networks associated with the respective SSIDs can be accessed and used by the client(s) 1700. The number of components shown herein are illustrative and there may be more or less in the access point 1000. The access point 1000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

In implementations, the client(s) 1700 can be, but is not limited to, a mobile device, stationary wireless capable and/or Wi-Fi devices and/or clients, end user devices, Internet Protocol (IP) devices, mobile computers, laptops, handheld computers, personal media devices, smartphones, notebooks, notepads, and/or the like, all of which can operate wirelessly with the access point 1000 via one of the primary SSID 1500 or secondary SSID(s) 1600.

In implementations, the controller 1100 can include, but is not limited to, a client control engine 1110, which in turn can operate with and/or include a monitor engine 1112, a pre-mitigation engine 1114, and a mitigation engine 1116.

In implementations, the client control engine 1110 can include, but is not limited to, logic to allow or disallow secondary SSID clients to associate and/or attach to the access point 1000 using a connection threshold based on a channel utilization. In implementations, the connection threshold is system configurable, user configurable, operator configurable, and/or combinations thereof. The client control engine 1110 can also initiate the monitor engine 1112 once client(s) are attached to the access point 1000 via the secondary SSID(s) 1600.

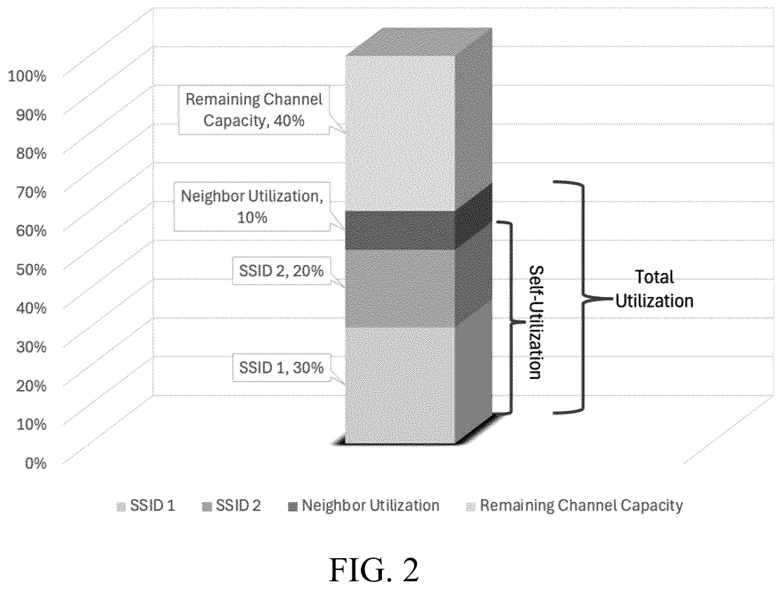

In implementations, the monitor engine 1112 can determine total on-channel utilization as described with respect to FIG. 2 below, can compare the total on-channel utilization against an imposition threshold, can calculate secondary SSID utilization to total on-channel utilization ratio, and can evaluate whether the access point 1000 should initiate the pre-mitigation engine 1114 or maintain monitoring with the monitor engine 1112. The imposition threshold controls how much capacity can be used and/or how much should be held in reserve on an on-going basis.

Reference is now made also to FIG. 2, which is a diagram of a graph of on-channel utilization in accordance with the teachings described herein. The methods and device described herein use total on-channel utilization at the access point. The total on-channel utilization includes self-utilization of the SSIDs and neighbor(s)′ utilization of overlapping SSIDs and corrupted packets. The self-utilization is the amount of channel capacity utilized due the access point's own traffic. This self-utilization amount can be further divided into utilization caused due to traffic on each SSID. For example, as shown in FIG. 2, the self-utilization total is 50% where SSID 1 has a 30% utilization and SSID 2 has a 20% utilization. The neighbor utilization is the amount of channel capacity utilized by neighboring access points plus any indiscernible or corrupted packets that the access point receives or detects. For example, as shown in FIG. 2, the neighbor utilization total is 10%

Referring now back to FIG. 1, in implementations, the pre-mitigation engine 1114 can measure and/or assess the latency of the primary SSID client(s) to detect whether the primary SSID clients'performance is degrading over a defined duration. In implementations, the defined duration is system configurable, user configurable, operator configurable, and/or combinations thereof. In the instance that the performance is not degrading over the defined duration, then the monitor engine 1112 is re-initiated. In the instance that the performance is degrading over the defined duration but the SNR of the primary SSID client(s) is not decreasing, then a client disassociation mode in the mitigation engine 1116 can be initiated. This reflects the view that the secondary SSID client(s) are negatively impacting the primary SSID clients'performance with minimum or no contribution from actions of the primary SSID client(s). In the instance that both the performance and the SNR are decreasing, then a client throttling mode in the mitigation engine 1116 can be initiated. This reflects the view that the secondary SSID client(s) are negatively impacting the primary SSID clients'performance with some contribution from actions of the primary SSID client(s). The throttling enables a measured approach to resolving the performance issue versus the drastic approach of disassociation.

In implementations, the mitigation engine 1116 can include a client disassociation mode and a client throttle mode as mentioned above to mitigate the decrease in the primary SSID clients'performance. In implementations, the client disassociation mode and the client throttle mode can be interrelated. In implementations, in the client disassociation mode, a secondary SSID client can be disassociated in an orderly or controlled fashion from a list of secondary SSID client as described herein. Once disassociated, the mitigation engine 1116 can re-initiate the pre-mitigation mode 1114 if additional secondary SSID client(s) are connected to the secondary SSID 1600. In implementations, in the client throttle mode, a list of the secondary SSID client(s) can be sorted from lowest to highest SNR. The mitigation engine 1116 can initiate throttling (e.g., decrease the amount of airtime and/or resources) the lowest ranked secondary SSID client, review primary SSID clients'performance, and move to a next ranked secondary SSID client if primary SSID clients'performance has not improved. Client throttling continues until the primary SSID clients'performance has improved or there are no more secondary SSID clients on the list or all secondary SSID clients on the list have been throttled. In the event there are no further secondary SSID clients and the primary SSID clients'performance has not improved, then the client disassociation mode can be initiated, starting with a lowest ranked secondary SSID client on a disconnect, disassociation, or drop list which is based on a variety of factors including, but not limited to, SNR, data usage, time connected, channel utilization, and/or combinations thereof. If the primary SSID clients'performance has improved, the mitigation mode 1116 can initiate the pre-mitigation engine 1114. If the primary SSID clients'performance has not improved, the mitigation mode 1116 can then disassociate a next ranked secondary SSID client on the disconnect list. This can continue until the primary SSID clients'performance has improved or there are no more secondary SSID clients on the disconnect list.

In implementations, the radio circuit 1200 can include, but is not limited to, a radio 1 1210 and may include a radio 2 1220. Each of the radio 1 1210 and the radio 2 1220 can operate on different bands. In a non-illustrative example, the bands can include, but are not limited to, 2.4 GHz, 5 GHz, and 6 GHz. Each band can include a defined number of channels. In implementations, a primary SSID and secondary SSID(s) can share the channel that the access point is currently using to transmit data to connected devices. This can be referred to as an on-channel or serving channel.

In implementations, the database 1300 can be one or more databases which can store on-channel utilization data, latency data, SNR data, and/or other metrics for enabling active secondary SSID client control. In implementations, the latency and SNR measurements can be taken and/or obtained by the access point 1000.

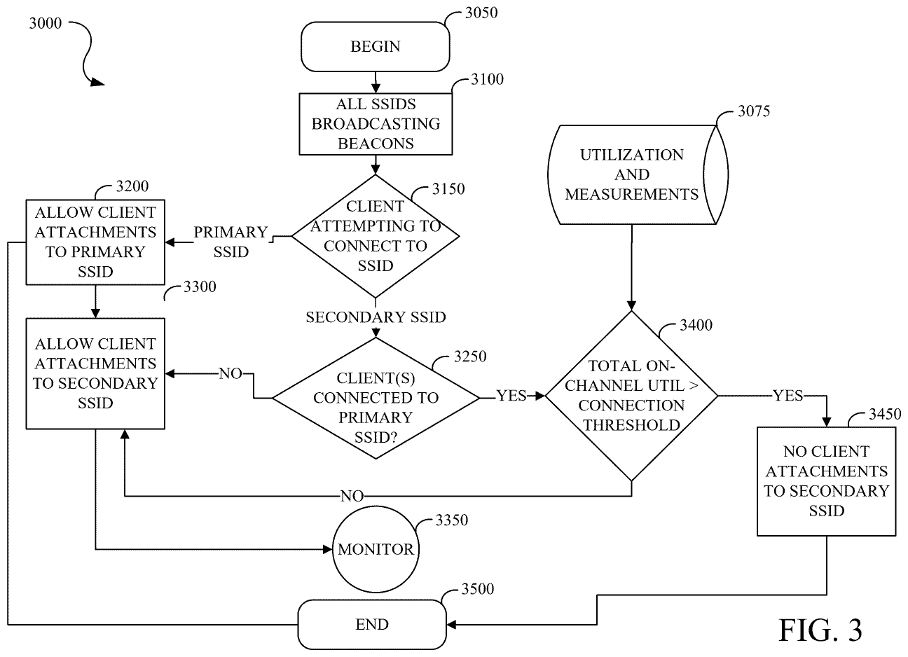

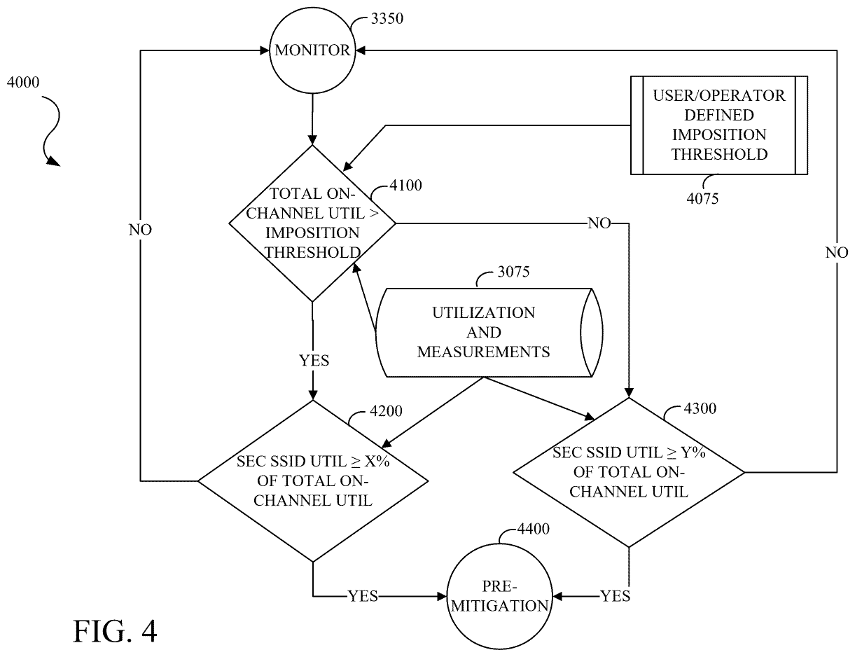

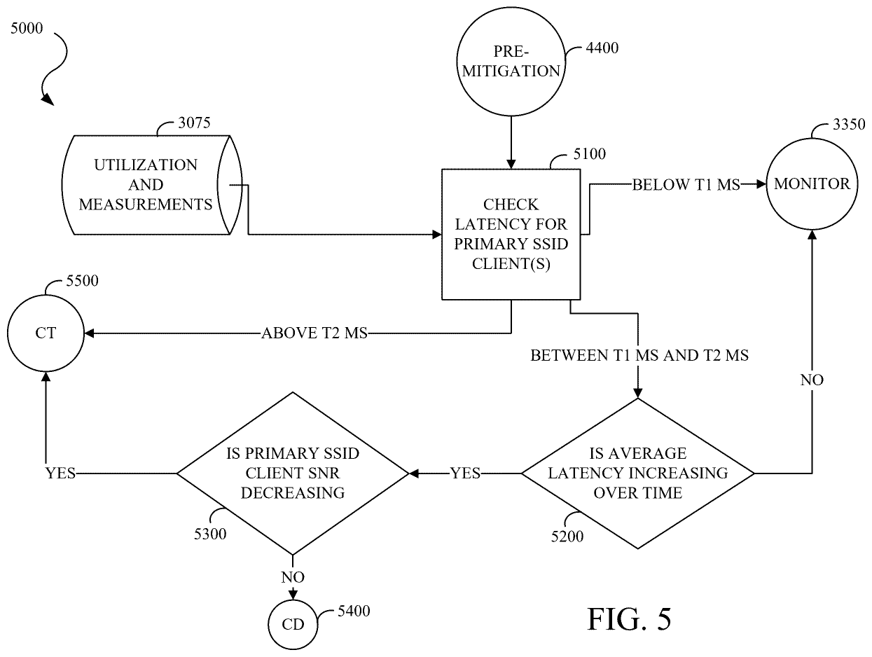

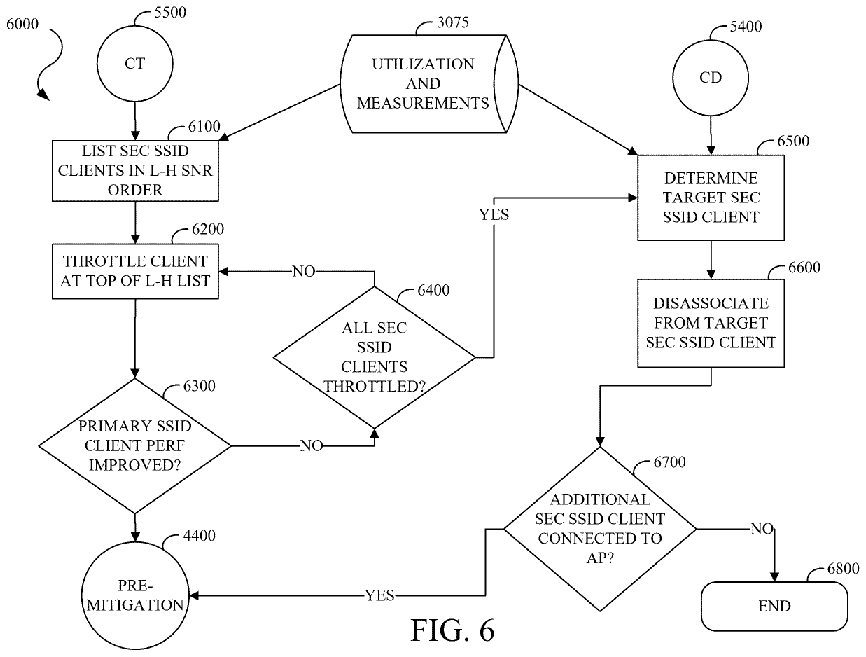

FIG. 3 is a flow diagram of an example client control engine flow 3000 for providing active secondary SSID client control in accordance with the teachings described herein, FIG. 4 is a flow diagram of an example monitor engine flow 4000 for providing active SSID client control in accordance with the teachings described herein, FIG. 5 is a flow diagram of an example pre-mitigation engine flow 5000 for providing active secondary SSID client control in accordance with the teachings described herein, and FIG. 6 is a flow diagram of an example mitigation engine flow 6000 for providing active secondary SSID client control in accordance with the teachings described herein. The client control engine flow 3000, the monitor engine flow 4000, the pre-mitigation engine flow 5000, and the mitigation engine flow 6000 are interoperable. In implementations, the access point 1000 can use the client control engine flow 3000, the monitor engine flow 4000, the pre-mitigation engine flow 5000, and the mitigation engine flow 6000 to provide active secondary SSID client control.

At 3050, in implementations, the client control engine flow 3000 can be initiated upon activating and/or powering on an access point. At 3100, all SSIDs, such as a primary SSID and a secondary SSID(s), supported by the access device can broadcast beacons so that clients can attach to the access point. At 3150, a determination can be made as to whether the client trying to attach is attaching to the primary SSID or the secondary SSID(s). If the client is trying to attach to the primary SSID, at 3200, the access point can permit the client to attach to the primary SSID and at 3500, the client control engine flow 3000 can end.

If the client is trying to attach to the secondary SSID, at 3250, a determination can be made as to whether there are any clients attached to the primary SSID. If there are no clients attached to the primary SSID, then at 3300, the access point can permit the client to attach to the secondary SSID. At 3350, the client control engine flow 3000 and/or access point can initiate the monitor engine flow 4000. If there are clients attached to the primary SSID, then at 3400, a determination can be made as to whether total on-channel utilization is greater than a connection threshold. The determination can be made using data from the database 3075. If the total on-channel utilization is less than or equal to the connection threshold, then at 3300, the access point can permit the client to attach to the secondary SSID. At 3350, the client control engine flow 3000 and/or access point can initiate the monitor engine flow 4000. If the total on-channel utilization is greater than the connection threshold, then at 3450, the access point can deny the client to attach to the secondary SSID and at 3500, the client control engine flow 3000 can end.

In the instance that the monitor engine flow 4000 has been initiated at 3350, then at 4100, a determination can be made as to whether total on-channel utilization is greater than an imposition threshold. In implementations, at 4075, the imposition threshold is system configurable, user configurable, operator configurable, and/or combinations thereof. The determination can be made using data from the database 3075. If the total on-channel utilization is greater than the imposition threshold, then at 4200, a determination is made as to whether the secondary SSID utilization is greater than or equal to a defined first percentage (e.g., X) of the total on-channel utilization. In implementations, the defined first percentage is system configurable, user configurable, operator configurable, and/or combinations thereof. In implementations, the defined first percentage can be 30%. The determination can be made using data from the database 3075. If the secondary SSID utilization is less than the defined percentage of the total on-channel utilization, then the monitor engine flow 4000 can return to 3350. If the secondary SSID utilization is greater than or equal to the defined percentage of the total on-channel utilization, then the pre-mitigation engine flow 5000 can be initiated at 4400.

If the total on-channel utilization is less than or equal to the imposition threshold, then at 4300, a determination is made as to whether the secondary SSID utilization is greater than or equal to a defined second percentage (e.g., Y) of the total on-channel utilization. In implementations, the defined second percentage is system configurable, user configurable, operator configurable, and/or combinations thereof. In implementations, the defined second percentage can be 50%. The determination can be made using data from the database 3075. The defined second percentage is greater than the first defined percentage. That is, X is less than Y. This reflects the fact that there is greater and/or more available on-channel capacity. If the secondary SSID utilization is less than the defined second percentage of the total on-channel utilization, then the monitor engine flow 4000 can return to 3350. If the secondary SSID utilization is greater than or equal to the defined second percentage of the total on-channel utilization, then the pre-mitigation engine flow 5000 can be initiated at 4400.

In the instance that the pre-mitigation engine flow 5000 has been initiated at 4400, then at 5100, the pre-mitigation engine flow 5000 and/or access point can check the latency of the primary SSID client(s). Data for the latency check can be obtained from the database 3075, which can contain latency and SNR measurements obtained and/or taken by the access point. If the latency values and/or numbers are below T1 milliseconds (a defined first time threshold) then the pre-mitigation engine flow 5000 can return to the monitor engine flow at 3350. In implementations, the T1 milliseconds is system configurable, user configurable, operator configurable, and/or combinations thereof. In implementations, the T1 milliseconds can be 60 milliseconds.

If the latency values and/or numbers are between T1 milliseconds and T2 milliseconds (a defined second time threshold), then at 5200, a determination can be made as to whether the average latency is increasing over a defined time period. In this instance, the term between is inclusive of the TI milliseconds and the T2 milliseconds. In implementations, the T2 milliseconds is system configurable, user configurable, operator configurable, and/or combinations thereof. In implementations, the T2 milliseconds can be 100 milliseconds. In implementations, T1 is less than T2.

If the average latency is not increasing over time, then the pre-mitigation engine flow 5000 can return to the monitor engine flow at 3350. If the average latency is increasing over time, then at 5300, a determination is made as to whether a SNR of the primary SSID client is decreasing. If the SNR of the primary SSID client is not decreasing, then the pre-mitigation engine flow 5000 can initiate client disassociation at 5400. If the SNR of the primary SSID client is decreasing, then the pre-mitigation engine flow 5000 can initiate client throttling at 5500. If the latency values and/or numbers are greater than T2 milliseconds, then the pre-mitigation engine flow 5000 can initiate client throttling at 5500.

In the instance that the mitigation engine flow 6000 has been initiated at client disassociation 5400, then at 6500, a target secondary SSID client can be selected. In implementations, the target secondary SSID client can be a secondary SSID client which is lowest ranked on a disconnect list. The data in the database 3075 can be used to make the selection. This reflects the fact that this client may be on the edge of the Wi-Fi coverage of the access point. At 6600, the target secondary SSID client can be disassociated. At 6700, the mitigation engine flow 6000 and/or access device can determine if there are additional secondary SSID clients attached to the access point. If there are no other secondary SSID clients attached to the access point, then the mitigation engine flow 6000 can end at 6800. If there are additional secondary SSID clients attached to the access point, then the mitigation engine flow 6000 can return to the pre-mitigation engine flow 4000 at 4400.

In the instance that the mitigation engine flow 6000 has been initiated at client throttling 5500, then at 6100, a list of secondary SSID clients can be generated in a lowest SNR to highest SNR order (i.e., a throttle list). The data in the database 3075 can be used to make the selection. At 6200, the lowest SNR secondary SSID client can be throttled. In implementations, a variety of techniques can be used to throttle a secondary SSID client. These techniques can include, but are not limited to, limiting airtime access, lowering the secondary SSID client's channel bandwidth, decrease a negotiated PHY rate, decrease the number of spatial streams, delaying ACKs, disable beamforming or MIMO, and/or combinations thereof. In a non-limiting illustration, a secondary SSID's 802.11ax, 80 MHz client connection can be dropped from 2×2 spatial streams to 1×1 and its PHY from 1201 Mbps to 600 Mbps. At 6300, a determination can be made as to whether the performance of the primary SSID client(s) has improved. If the performance of the primary SSID client(s) has improved, then the mitigation engine flow 6000 can return to the pre-mitigation engine flow 4000 at 4400. If the performance of the primary SSID client(s) has not improved, then at 6400, a determination is made as to whether all secondary SSID clients have been throttled. If all secondary SSID clients have not been throttled, then at 6200, a next lowest secondary SSID client is throttled and the process continues until all the performance of the primary SSID client(s) has improved or all secondary SSID clients have been throttled. If all secondary SSID clients have been throttled, then the mitigation engine flow 6000 can determine a target secondary SSID client for disassociation at 6500 and follow the process as described herein.

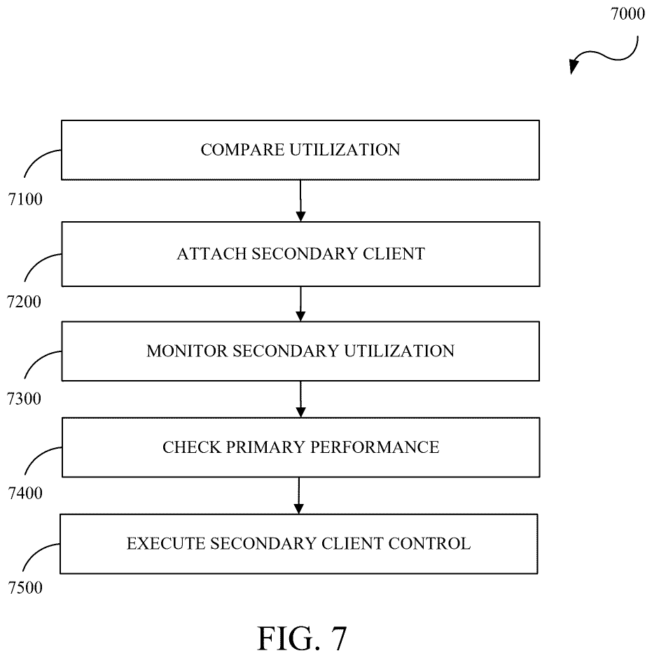

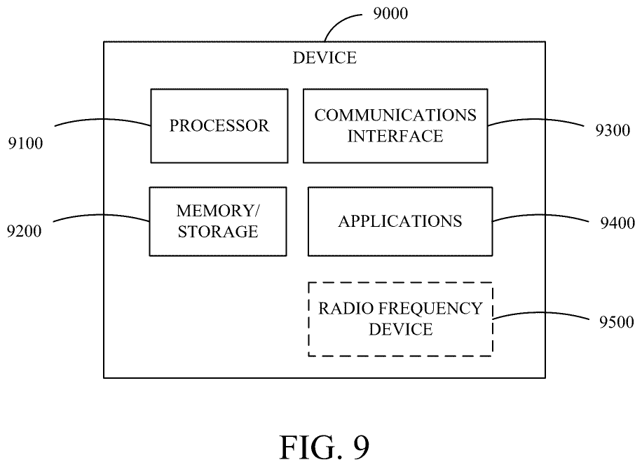

FIG. 7 is a flowchart of an example method 7000 for providing active secondary SSID client control in accordance with the teachings described herein. The method 7000 includes: comparing 7100 a total on-channel utilization against a connection threshold; attaching 7200 a client to a secondary SSID when the total on-channel utilization is less than the connection threshold; monitoring 7300 secondary SSID utilization with respect to the total on-channel utilization; checking 7400 performance of primary SSID client when the secondary SSID utilization exceeds or is equal to a defined threshold; and executing 7500 one of client throttling or client disassociation of secondary SSID clients when the performance of primary SSID client is degraded. The method 7000 can be implemented, for example, in or by components described with respect to FIGS. 1 and 9 and in conjunction with any of the flows described with respect to FIGS. 3-6 and 8, as appropriate and applicable.

The method 7000 includes comparing 7100 a total on-channel utilization against a connection threshold and attaching 7200 a client to a secondary SSID when the total on-channel utilization is less than the connection threshold. The access point can have a primary SSID and a secondary SSID. In implementations, there can be multiple secondary SSIDs. The access point and the methods and/or flows described herein initially check total on-channel utilization against the connection threshold before permitting any clients to attach to the secondary SSID when there is a client attached to the primary SSID.

The method 7000 includes monitoring 7300 secondary SSID utilization with respect to the total on-channel utilization. Once clients are attached to the secondary SSID, the access point can monitor the secondary SSID utilization with respect to the total on-channel utilization. The access point can initially check the total on-channel utilization against an imposition threshold. The access point then checks what percentage of the total on-channel utilization is contributed by the secondary SSID utilization. Different thresholds or percentages can be used based on the initial total on-channel utilization check. More secondary SSID utilization can be allowed for lower total on-channel utilization.

The method 7000 includes checking 7400 performance of primary SSID client when the secondary SSID utilization exceeds or is equal to a defined threshold. As noted above, there are two thresholds in play depending on the total on-channel utilization value. The defined threshold here is meant to cover or refer to both of the two thresholds. Once the defined threshold is at least met, then a primary SSID client performance check is initiated. The performance check reviews at least latency and can check SNR depending on the latency level or latency trends.

The method 7000 includes executing 7500 one of client throttling or client disassociation of secondary SSID clients when the performance of primary SSID client is degraded. Once the performance of the primary SSID client is impacted, the access point can initiate client throttling, client disassociation, and/or both depending on what needs to be done with respect to the secondary SSID clients to improve the performance of the primary SSID client.

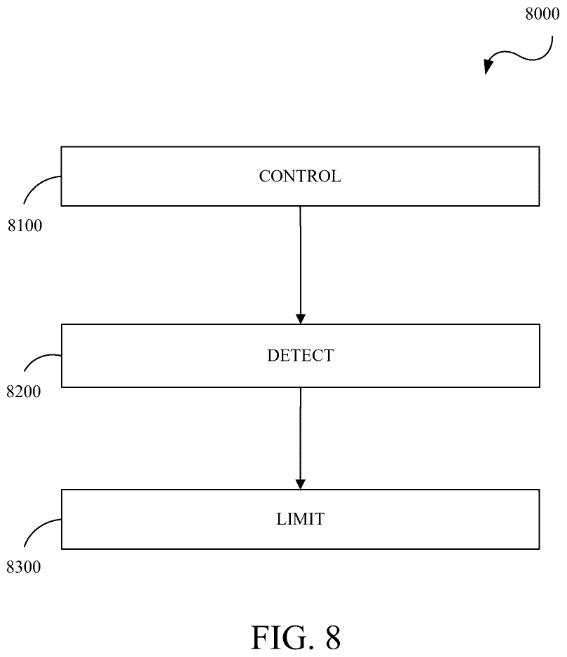

FIG. 8 is a flowchart of an example method 8000 for providing active secondary SSID client control in accordance with the teachings described herein. The method 8000 includes: controlling 8100 attachment to secondary SSID based on primary SSID; detecting 8200 whether performance of primary SSID client is being impacted by secondary SSID clients; and limiting 8300 resources to the secondary SSID clients based on a degraded performance of the primary SSID client. The method 8000 can be implemented, for example, in or by components described with respect to FIGS. 1 and 9 and in conjunction with any of the flows described with respect to FIGS. 3-7, as appropriate and applicable.

The method 8000 includes controlling 8100 attachment to secondary SSID based on primary SSID. The access point can have a primary SSID and a secondary SSID. In implementations, there can be multiple secondary SSIDs. The access point and the methods and/or flows described herein initially check total on-channel utilization against the connection threshold before permitting any clients to attach to the secondary SSID when there is a client attached to the primary SSID. That is, attachments to the secondary SSID are based on primary SSID clients and/or attachments, utilization, and/or combinations thereof.

The method 8000 includes detecting 8200 whether performance of primary SSID client is being impacted by secondary SSID clients. Once clients are attached to the secondary SSID, the access point can monitor the secondary SSID utilization with respect to the total on-channel utilization. The access point can initially check the total on-channel utilization against an imposition threshold. The access point then checks what percentage of the total on-channel utilization is contributed by the secondary SSID utilization. Different thresholds can be used based on the initial total on-channel utilization check. More secondary SSID utilization can be allowed for lower total on-channel utilization. As noted above, there are two thresholds in play depending on the total on-channel utilization value. The defined threshold here is meant to cover or refer to both of the two thresholds. Once the defined threshold is at least met, then a primary SSID client performance check is initiated. The performance check reviews at least latency and can check SNR depending on the latency level or latency trends.

The method 8000 includes limiting 8300 resources to the secondary SSID clients based on a degraded performance of the primary SSID client. Once the performance of the primary SSID client is impacted, the access point can initiate client throttling, client disassociation, and/or both depending on what needs to be done with respect to the secondary SSID clients to improve the performance of the primary SSID client.

FIG. 9 is a block diagram of an example of a device 9000 in accordance with the teachings described herein. The device 9000 may include, but is not limited to, a processor 9100, a memory/storage 9200, a communication interface 9300, applications 9400, and, if needed, a radio frequency device 9500. The device 9000 may include or implement, for example, the device and components described with respect to FIG. 1 and the implement the methods of FIGS. 3-8. The applicable or appropriate flows, techniques, or methods described herein may be stored in the memory/storage 9200 and executed by the processor 9100 in cooperation with the memory/storage 9200, the communications interface 9300, the applications 9400, and the radio frequency device 9500 (when applicable), as appropriate. The device 9000 may include other elements which may be desirable or necessary to implement the devices, systems, and methods described herein. However, because such elements and steps do not facilitate a better understanding of the disclosed embodiments, a discussion of such elements and steps may not be provided herein.

Disclosed is a method for providing active secondary service set identifier (SSID) client control. In implementations, a method for providing active secondary service set identifier (SSID) client control includes comparing, by a client control engine in an access point, a total on-channel utilization against a connection threshold when a client attempts to attach to a secondary SSID of the access point, wherein the total on-channel utilization includes utilization across a primary SSID and the secondary SSID, attaching, by the access point, the client to the secondary SSID when the total on-channel utilization is less than the connection threshold, monitoring, by a monitor engine of the client control engine, secondary SSID utilization with respect to the total on-channel utilization, checking, by a pre-mitigation engine of the client control engine, performance of a primary SSID client when the secondary SSID utilization exceeds or is equal to a defined percentage of the total on-channel utilization, and executing, by a mitigation engine of the client control engine, at least one of a client throttling or a client disassociation of at least one secondary SSID client when the performance of the primary SSID client is degraded.

In implementations, the method includes checking, by the client control engine, whether a client is attached to the primary SSID. In implementations, the method includes initiating, by the client control engine, the monitor engine when the client is attached to the secondary SSID. In implementations, the monitoring further includes comparing, by the monitor engine, the total on-channel utilization against an imposition threshold, determining, by the monitor engine, whether the secondary SSID utilization is greater than or equal to a defined first percentage of the total on-channel utilization when the total on-channel utilization is greater than the imposition threshold, determining, by the monitor engine, whether the secondary SSID utilization is greater than or equal to a defined second percentage of the total on-channel utilization when the total on-channel utilization is equal or less than the imposition threshold, and initiating, by the monitor engine, the pre-mitigation engine when the secondary SSID utilization is greater than or equal to one of the defined first percentage or the defined first second, where the defined first percentage is less than the defined second percentage, and where the defined percentage is one of the defined first percentage or the defined first second. In implementations, the checking further includes returning, by the pre-mitigation engine, to the monitor engine to continue the monitoring when a latency value for the primary SSID client is below a defined first time threshold. In implementations, where the checking further includes checking, by the pre-mitigation engine, whether the latency is increasing over a defined time period when the latency value for the primary SSID client is between the defined first time threshold and a defined second time threshold, wherein the defined first time threshold is less than the defined second time threshold, and checking, by the pre-mitigation engine, whether a signal-to-noise ratio for the primary SSID client is decreasing when the latency is increasing over the defined time period, and the executing further includes executing, by the mitigation engine, the client dissociation when the signal-to-noise ratio for the primary SSID client is not decreasing, and executing, by the mitigation engine, the client throttling when the signal-to-noise ratio for the primary SSID client is decreasing. In implementations, where a first instance of the checking further includes returning, by the pre-mitigation engine, to the monitor engine to continue the monitoring when the latency is not increasing over the defined time period. In implementations, where a first instance of the checking further includes checking, by the pre-mitigation engine, whether the latency is above the defined second time threshold, and a first instance of the executing further includes executing, by the mitigation engine, the client throttling when the latency is above the defined second time threshold. In implementations, where the executing further includes for the client disassociation: determining, by the mitigation engine, a target secondary SSID client, disassociating, by the mitigation engine, the target secondary SSID client, and returning, by the mitigation engine, to the pre-mitigation engine to check the performance of the primary SSID client when an additional secondary SSID client remains attached to the access point. In implementations, where the executing further includes for the client throttling: generating, by the mitigation engine, a list of secondary SSID clients from lowest signal-to-noise ratio to highest signal-to-noise ratio; throttling, by the mitigation engine, the secondary SSID client on top of the list, and re-checking the performance of the primary SSID client, where the throttling and re-checking continue until the performance of the primary SSID client has improved or all secondary SSID clients on the list have been throttled. In implementations, the executing further includes for the client throttling: returning, by the mitigation engine, to the pre-mitigation engine to continue checking the performance of the primary SSID client when the performance of the primary SSID client has improved. In implementations, where the executing further include for the client throttling: initiating, by the mitigation engine, the client disassociation when the performance of the primary SSID client has not improved and all secondary SSID clients have been throttled.

Disclosed is a method for providing active secondary service set identifier (SSID) client control. In implementations, the method includes controlling, by an access point, attachment by a client to a secondary SSID based on at least one primary SSID client, detecting, by the access point, whether performance of a primary SSID client is being impacted by secondary SSID clients, and limiting, by the access point, resources to the secondary SSID clients based on a degraded performance of the primary SSID client.

In implementations, the controlling further includes checking, by the access point, total on-channel utilization against a connection threshold due to the presence of the at least one primary SSID client, attaching, by the access point, the client to the secondary SSID when the total on-channel utilization is less than the connection threshold, and initiating, by the access point, monitoring of the total on-channel utilization when the client is attached to the secondary SSID. In implementations, the detecting further includes monitoring, by the access point, secondary SSID utilization with respect to total on-channel utilization when the client is attached to the secondary SSID, and determining, by the access point, a latency of the primary SSID client when the secondary SSID utilization exceeds or is equal to a defined percentage of the total on-channel utilization. In implementations, the determining further includes checking, by the access point, whether a signal-to-noise ratio for the primary SSID client is decreasing when a latency of the primary SSID client is increasing over a defined time period. In implementations, the limiting further includes performing, by the access point, a client disassociation of at least one secondary SSID client when the signal-to-noise ratio for the primary SSID client is not decreasing and the latency for the primary SSID client is increasing over the defined time period. In implementations, the limiting further includes performing, by the access point, a client throttling of at least one secondary SSID client when the signal-to-noise ratio for the primary SSID client is decreasing and the latency for the primary SSID client is increasing over the defined time period. In implementations, the limiting further includes performing, by the access point, a client disassociation of the at least one secondary SSID client when the client throttling of the at least one secondary SSID client is insufficient to improve the performance of the primary SSID client.

Disclosed is a access point for providing active secondary service set identifier (SSID) client control. In implementations, the access point includes a radio circuit configured to broadcast a primary service set identifier (SSID) and a secondary SSID, and a controller. The controller is configured to perform attachment control on a client attempting to attach to the secondary SSID based on presence of primary SSID clients and total on-channel utilization, evaluate whether performance of the primary SSID clients is degraded due to ratio of secondary SSID utilization and the total on-channel utilization, and execute at least one of client throttling or a client disassociation of at least one secondary SSID client when the performance of the primary SSID client is degraded.

Although some teachings and/or embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to teachings and/or embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various teachings and/or embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain teachings and/or embodiments, it is to be understood that the disclosure is not to be limited to the disclosed teachings and/or embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for providing active secondary service set identifier (SSID) client control, the method comprising:
comparing, by a client control engine in an access point, a total on-channel utilization against a connection threshold when a client attempts to attach to a secondary SSID of the access point, wherein the total on-channel utilization includes utilization across a primary SSID and the secondary SSID;
attaching, by the access point, the client to the secondary SSID when the total on-channel utilization is less than the connection threshold;
monitoring, by a monitor engine of the client control engine, secondary SSID utilization with respect to the total on-channel utilization;
checking, by a pre-mitigation engine of the client control engine, performance of a primary SSID client when the secondary SSID utilization exceeds or is equal to a defined percentage of the total on-channel utilization; and
executing, by a mitigation engine of the client control engine, at least one of a client throttling or a client disassociation of at least one secondary SSID client when the performance of the primary SSID client is degraded.

2. The method of claim 1, further comprising:
checking, by the client control engine, whether a client is attached to the primary SSID.

3. The method of claim 1, further comprising:
initiating, by the client control engine, the monitor engine when the client is attached to the secondary SSID.

4. The method of claim 1, wherein the monitoring further comprising:
comparing, by the monitor engine, the total on-channel utilization against an imposition threshold;
determining, by the monitor engine, whether the secondary SSID utilization is greater than or equal to a defined first percentage of the total on-channel utilization when the total on-channel utilization is greater than the imposition threshold;
determining, by the monitor engine, whether the secondary SSID utilization is greater than or equal to a defined second percentage of the total on-channel utilization when the total on-channel utilization is equal or less than the imposition threshold; and
initiating, by the monitor engine, the pre-mitigation engine when the secondary SSID utilization is greater than or equal to one of the defined first percentage or the defined second percentage,
wherein the defined first percentage is less than the defined second percentage, and
wherein the defined percentage is one of the defined first percentage or the defined second percentage.

5. The method of claim 1, wherein the checking further comprising:
returning, by the pre-mitigation engine, to the monitor engine to continue the monitoring when a latency value for the primary SSID client is below a defined first time threshold.

6. The method of claim 5, wherein:
the checking further comprising:
checking, by the pre-mitigation engine, whether the latency is increasing over a defined time period when the latency value for the primary SSID client is between the defined first time threshold and a defined second time threshold, wherein the defined first time threshold is less than the defined second time threshold; and
checking, by the pre-mitigation engine, whether a signal-to-noise ratio for the primary SSID client is decreasing when the latency is increasing over the defined time period, and
the executing further comprising:
executing, by the mitigation engine, the client disassociation when the signal-to-noise ratio for the primary SSID client is not decreasing; and
executing, by the mitigation engine, the client throttling when the signal-to-noise ratio for the primary SSID client is decreasing.

7. The method of claim 6, wherein a first instance of the checking further comprising:
returning, by the pre-mitigation engine, to the monitor engine to continue the monitoring when the latency is not increasing over the defined time period.

8. The method of claim 6, wherein:
a first instance of the checking further comprising:
checking, by the pre-mitigation engine, whether the latency is above the defined second time threshold; and
a first instance of the executing further comprising:
executing, by the mitigation engine, the client throttling when the latency is above the defined second time threshold.

9. The method of claim 1, wherein the executing further comprising:
for the client disassociation:
determining, by the mitigation engine, a target secondary SSID client;
disassociating, by the mitigation engine, the target secondary SSID client; and
returning, by the mitigation engine, to the pre-mitigation engine to check the performance of the primary SSID client when an additional secondary SSID client remains attached to the access point.

10. The method of claim 9, wherein the executing further comprising:
for the client throttling:
generating, by the mitigation engine, a list of secondary SSID clients from lowest signal-to-noise ratio to highest signal-to-noise ratio;
throttling, by the mitigation engine, the secondary SSID client on top of the list; and
re-checking the performance of the primary SSID client,
wherein the throttling and re-checking continue until the performance of the primary SSID client has improved or all secondary SSID clients on the list have been throttled.

11. The method of claim 10, wherein the executing further comprising:
for the client throttling:
returning, by the mitigation engine, to the pre-mitigation engine to continue checking the performance of the primary SSID client when the performance of the primary SSID client has improved.

12. The method of claim 10, wherein the executing further comprising:
for the client throttling:
initiating, by the mitigation engine, the client disassociation when the performance of the primary SSID client has not improved and all secondary SSID clients have been throttled.

13. A method for providing active secondary service set identifier (SSID) client control, the method comprising:
controlling, by an access point, attachment by a client to a secondary SSID based on at least one primary SSID client;
detecting, by the access point, whether performance of a primary SSID client is being impacted by secondary SSID clients; and
limiting, by the access point, resources to the secondary SSID clients based on a degraded performance of the primary SSID client.

14. The method of claim 13, wherein the controlling further comprising:
checking, by the access point, total on-channel utilization against a connection threshold due to a presence of the at least one primary SSID client;
attaching, by the access point, the client to the secondary SSID when the total on-channel utilization is less than the connection threshold; and
initiating, by the access point, monitoring of the total on-channel utilization when the client is attached to the secondary SSID.

15. The method of claim 13, wherein the detecting further comprising:
monitoring, by the access point, secondary SSID utilization with respect to total on-channel utilization when the client is attached to the secondary SSID; and
determining, by the access point, a latency of the primary SSID client when the secondary SSID utilization exceeds or is equal to a defined percentage of the total on-channel utilization.

16. The method of claim 13, wherein the detecting further comprising:
checking, by the access point, whether a signal-to-noise ratio for the primary SSID client is decreasing when a latency of the primary SSID client is increasing over a defined time period.

17. The method of claim 16, wherein the limiting further comprising:
performing, by the access point, a client disassociation of at least one secondary SSID client when the signal-to-noise ratio for the primary SSID client is not decreasing and the latency for the primary SSID client is increasing over the defined time period.

18. The method of claim 16, wherein the limiting further comprising:
performing, by the access point, a client throttling of at least one secondary SSID client when the signal-to-noise ratio for the primary SSID client is decreasing and the latency for the primary SSID client is increasing over the defined time period.

19. The method of claim 18, wherein the limiting further comprising:
performing, by the access point, a client disassociation of the at least one secondary SSID client when the client throttling of the at least one secondary SSID client is insufficient to improve the performance of the primary SSID client.

20. An access point, comprising:
a radio circuit configured to broadcast a primary service set identifier (SSID) and a secondary SSID; and
a controller configured to:
perform attachment control on a client attempting to attach to the secondary SSID based on presence of primary SSID clients and total on-channel utilization;
evaluate whether performance of the primary SSID clients is degraded due to ratio of secondary SSID utilization and the total on-channel utilization; and
execute at least one of client throttling or a client disassociation of at least one secondary SSID client when the performance of the primary SSID client is degraded.
